(19) United States
(12) Patent Application Publication
(10) Pub. No.: US 2026/0189563 A1
(43) Pub. Date: Jul. 2, 2026

(54) DYNAMIC DATA STATE CONTROL BASED ON SOURCE SYSTEM SIGNALS

(71) Applicants: Yuvaraj Chandrasekaran, Mansfield, TX (US); Saranya Sundaramani, Mansfield, TX (US); Manasvi Yuvaraj, Mansfield, TX (US)

(72) Inventors: Yuvaraj Chandrasekaran, Mansfield, TX (US); Saranya Sundaramani, Mansfield, TX (US); Manasvi Yuvaraj, Mansfield, TX (US)

(21) Appl. No.: 19/004,429

(22) Filed: Dec. 29, 2024

(51) Int. Cl. H04L 9/40

(52) U.S. Cl. CPC H04L 63/101; H04L 63/102; H04L 63/108

(57) ABSTRACT

A system and method for dynamic data state management in distributed systems utilizing real-time signals from dynamic source systems to control data accessibility. The invention leverages signal objects generated by source systems, such as mobile and desktop devices, to dynamically construct access control mechanisms based on temporal constraints, user contexts, and access permissions. These signal objects are transmitted to an application server, where they are analyzed to adjust the states of corresponding data objects in real time. The application server modifies the visibility, availability, and accessibility of the data objects and serves them to client systems according to the adjusted states. The invention ensures secure, context-specific, and flexible data access by continuously monitoring and dynamically updating data states in response to evolving conditions. Applications include secure data sharing, context-aware access, and real-time permission management in distributed environments.

### BACKGROUND

In traditional distributed systems, ensuring secure and context-specific data access is paramount for safeguarding sensitive information and maintaining system integrity. These systems typically consist of multiple interconnected components, such as client applications, application servers, and data stores, which interact to provide real-time access to data. However, conventional methods for managing data access often rely on static, predefined configurations. These configurations typically define user roles, access permissions, and data access patterns based on fixed criteria, which do not adapt to the dynamic nature of modern distributed environments.

A key challenge with such static configurations is that they fail to account for dynamic conditions such as temporal constraints, user context, and evolving access control requirements. For example, access privileges may vary depending on factors such as the time of day, the specific context of the user's request, or the dynamic state of the underlying data. As a result, existing solutions often suffer from limited flexibility and may grant access to sensitive data in situations where access should be restricted, or conversely, fail to provide access in situations where it should be permitted.

Furthermore, traditional systems may not adequately address the complexity of coordinating access across multiple source systems that generate or manage the data. This can result in inconsistent or inaccurate data being made available to client systems, leading to security vulnerabilities, performance issues, or reduced system reliability.

The present invention addresses these challenges by introducing a mechanism where source systems dynamically influence the state of data objects within application servers. By considering factors such as real-time user context, temporal conditions, and specific access control requirements, this invention enables a more precise and secure model for data access. Specifically, the invention enables the dynamic modification of data states based on real-time inputs from source systems, ensuring that client systems are only granted access to the data that is both appropriate and permissible under the current conditions. This dynamic approach provides a more flexible, context-aware solution to data access, thereby enhancing the overall security and functionality of distributed systems.

### SUMMARY

The present invention provides a system and method for dynamically managing the state of data objects in distributed environments, ensuring secure, context-specific, and real-time data access. The invention addresses limitations in traditional static systems, which rely on predefined and rigid configurations that fail to adapt to dynamic conditions such as temporal constraints, contextual access requirements, and real-time operational changes.

At its core, the invention leverages a source system, comprising mobile and desktop devices executing distinct configurations of an application, to generate data and the signals that govern the state of data objects in an application server. These signals are multi-dimensional, incorporating temporal parameters and data access control objects to dynamically adjust the data objects'visibility, availability, and accessibility. This innovative approach enables real-time control over data access, tailored to the specific needs of client systems.

The temporal parameters define time-based conditions under which data access is allowed. Examples include specific time windows, duration constraints, or recurring intervals during which data objects can be accessed. The data access control objects specify user roles, permissions, device configurations, and contextual attributes, creating a robust framework for precise access control.

Unlike traditional systems that rely on static data sources, the present invention introduces a dynamic data source model. In this model, a specific system can act as a data source for another system within constrained environments. Access to data in these environments is governed by time and accessibility parameters, ensuring that data objects are available only under the appropriate conditions. This dynamic nature of the source system allows for seamless, context-aware interaction between interconnected systems, enhancing both flexibility and security.

The application server serves as the central processing unit for the signals generated by the source system. Upon receiving these signals, the server dynamically modifies the state of the data objects. This includes:
Visibility: Determining whether specific data objects are displayed to client systems.
Availability: Ensuring the data objects can be accessed in their current state.
Accessibility: Defining the level of interaction (e.g., read, write, or execute) permitted for each client system.

Once the state of the data objects is adjusted, the application server serves them to client systems, enabling secure and context-specific access. This real-time adaptability improves operational efficiency by ensuring that only the appropriate users, under the correct conditions, can access the required data.

The invention also introduces a flexible framework for interdependent application environments. It eliminates the need for static access control mechanisms, allowing distributed systems to operate in dynamic and constrained environments. The system's capability to dynamically adjust data states based on context ensures compliance with security policies while maintaining the usability and functionality of the system.

This innovative approach has wide-ranging applications in sectors requiring secure and adaptable data management, such as cloud computing, enterprise systems, healthcare, and financial services. By addressing the limitations of static systems, the invention provides a robust, flexible, and secure solution for modern distributed environments.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a system architecture, depicting high-level interactions between the source system, application server, and client system.

FIG. 2 illustrates a flowchart of a method for signal generation and data state control process, according to some embodiments.

FIG. 3 illustrates a detailed system architecture, depicting detailed interactions between the source system, application server, and client system.

FIG. 4 illustrates a data object divided into portions corresponding to different application configurations, according to some embodiments.

FIG. 5 illustrates a simplified block diagram of a distributed system for implementing some of the embodiments.

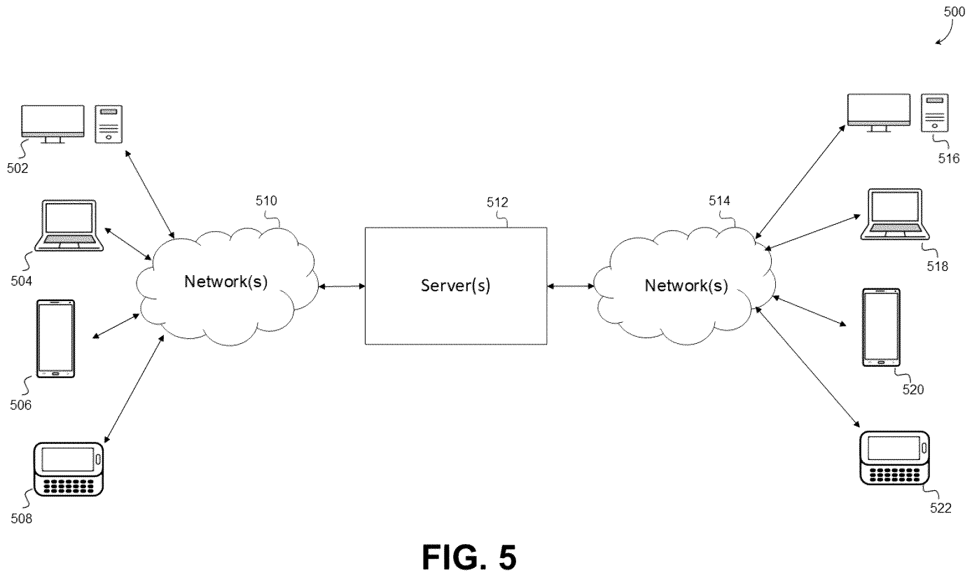

FIG. 6 illustrates a signal object divided into portions corresponding to different application configurations, according to some embodiments.

FIG. 7A illustrates an example of a data object and signal object sent by the source system, processed by the server, and finally sent to the client system according to some embodiments.

FIG. 7B illustrates an example of a data object and signal object, invalidating the data object sent by the source system, processed by the server, and finally sent to the client system according to some embodiments.

FIG. 7C illustrates an example of a single element of the data object as data and signal object sent by the source system, processed by the server, and finally sent to the client system according to some embodiments.

FIG. 7D illustrates an example of a few elements of the data object as data and signal object sent by the source system, processed by the server, and finally sent to the client system according to some embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.
1. SYSTEM OVERVIEW
2. ARCHITECTURAL OVERVIEW
3. KEY FEATURES
4. DATA OBJECT EXPLAINED
5. SIGNAL OBJECT EXPLAINED
6. DETAILED PROCESS FLOW

### 1. SYSTEM OVERVIEW

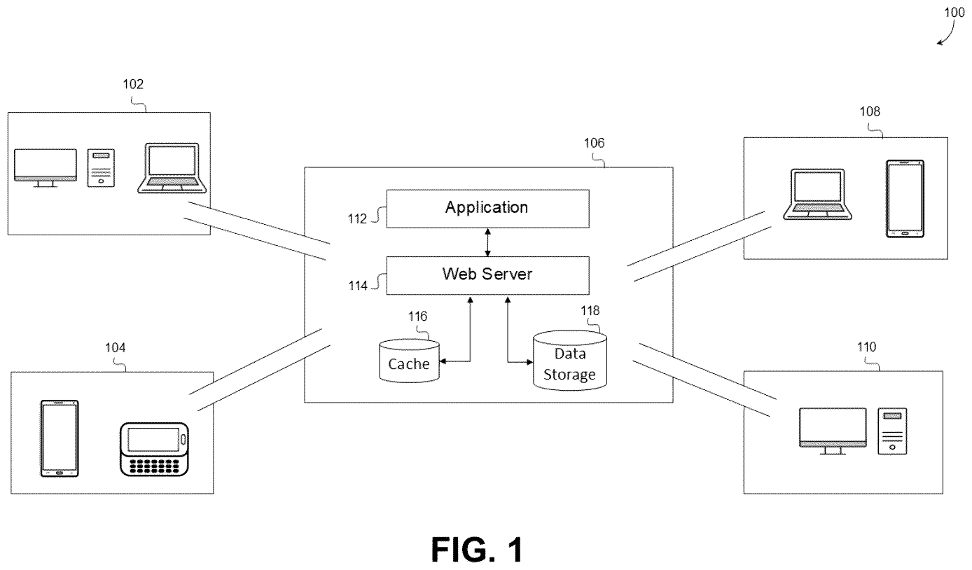

FIG. 1 illustrates a system 100, the Source System (102 and 104) is a foundational component of the invention, responsible for initiating and transmitting data, signals, or processes. It acts as the origin point for dynamic interactions within the system, enabling seamless communication with other components such as the application server (106) and client systems (108 and 110). The source system(s) (102 and 104) is designed to ensure flexibility, configurability, and real-time responsiveness. The dynamic nature of the source system arises from its composition as a collection (or plurality) of multiple interconnected systems. Each of these systems contributes by selectively transmitting data and signals. The targeted client system receives this data and signals, which are determined based on specific conditions or configurations. Below are the key attributes of the source system:
Dynamic Nature: The source system operates in real-time, continuously adapting to changing conditions. Signals and data are transmitted frequently and consistently over a defined period, enabling the system to remain dynamic and up-to-date.
Plurality Reference: The source system includes multiple interconnected systems that collaborate and interact dynamically. These systems contribute diverse signals and data, ensuring flexibility and distributed functionality.
Selective Transmission: Data and signals sent to the client system are carefully chosen based on specific criteria such as user permissions, operational requirements, and context. This selection happens dynamically and incorporates temporal elements to ensure relevance and accuracy.
Temporal Constraints and Frequent Updates: Signals and data are transmitted repeatedly and consistently over time to keep the application server updated with the most recent data states and access control lists (ACLs). This ensures that data availability, visibility, and accessibility remain aligned with evolving conditions and temporal parameters, such as scheduled updates or user sessions.
Target-Oriented Functionality: The system's ultimate goal is to effectively serve the target client system by providing real-time updates on data states and access permissions. By ensuring frequent and accurate communication, the system maintains synchronization between the source system, application server, and client system.

The Application Server (106) is the central processing component of the system, responsible for managing the state of data objects and facilitating secure, context-specific data access for client systems. It acts as the intermediary between the source systems and client systems, processing incoming signals and ensuring the appropriate visibility, availability, and accessibility of data objects.

The application server comprises as a plurality of interconnected systems that collaboratively manage the state of data objects and enable secure, context-specific data access for client systems. It acts as a distributed processing entity between the source systems and client systems, with each component contributing to the overall functionality of the server. Below are the key functionalities of the application server:
Signal Processing: The application server receives signals from the source system. These signals, which are a combination of data access control objects and temporal parameters, dictate the state of data objects. Example: A signal might specify that a data object should only be visible to a particular client system for a defined time period.
Data State Management: The application server dynamically adjusts the state of data objects based on the received signals. For example, a data object might only be accessible during a specific time window or after a periodic refresh. The server adapts the visibility and accessibility of data objects based on the unique requirements of each client system and its environment. The application server continuously updates the data object states as new signals and updates are received from the source system. By enforcing strict access control and synchronization with source systems, the server ensures data is protected and accessible only to authorized clients. This includes:
   Visibility: Determining whether a data object is discoverable by client systems.
   Availability: Specifying when a data object can be accessed.
   Accessibility: Controlling user permissions for interacting with the data object.
   Flexibility: The application server can adapt to a wide range of scenarios by dynamically adjusting data object states.
Synchronization: The server ensures real-time synchronization between the source system and client systems. Frequent updates, based on continuous transmission of signals from the source system, keep the application server in sync with the most recent data state and access control configurations.
Authorization and Security: The application server enforces robust authentication and authorization mechanisms to ensure only authorized client systems and users can access the data objects. Access control is governed by the parameters defined in the signals received from the source systems.
Data Serving: Once the data object state is adjusted, the server serves the updated data objects to client systems, ensuring they receive accurate and contextually relevant data. Example: A client system querying for a report will only receive the data it is authorized to access based on its temporal constraints and permissions.
Logging and Monitoring: The application server maintains logs of all signals, data state changes, and client accesses to ensure accountability and facilitate troubleshooting. Monitoring tools provide real-time insights into server operations, enabling proactive system management.

The Client Systems (108 and 110) represent the endpoints in the data management ecosystem, where authorized users or systems access data objects processed and served by the application server. These systems are versatile, comprising a combination of mobile devices, desktop computers, and other computational platforms, each equipped to interface with the application server for secure and context-specific data consumption.

Client systems include mobile devices (e.g., smartphones, tablets) and desktop devices (e.g., PCs, laptops) running various configurations of applications. These systems can operate on different operating systems and environments, ensuring wide accessibility. The client systems dynamically adapt their requests and processing capabilities based on the type of data objects they receive. For example, a mobile device may request optimized, lightweight data, while a desktop system might retrieve full datasets for detailed processing. Examples of Use Cases for Client Systems:
Mobile Device: A salesperson uses a smartphone to access real-time inventory data before meeting a client. The application server ensures the data is updated to the most recent state and served securely.
Desktop Computer: An analyst retrieves a detailed dataset from the application server for visualization and trend analysis. The desktop system handles the full dataset's complexity efficiently.
IoT Device: A smart thermostat accesses the application server to retrieve temperature and energy usage data. The data state is dynamically adjusted to reflect the current conditions in the source system.

### 2. ARCHITECTURAL OVERVIEW

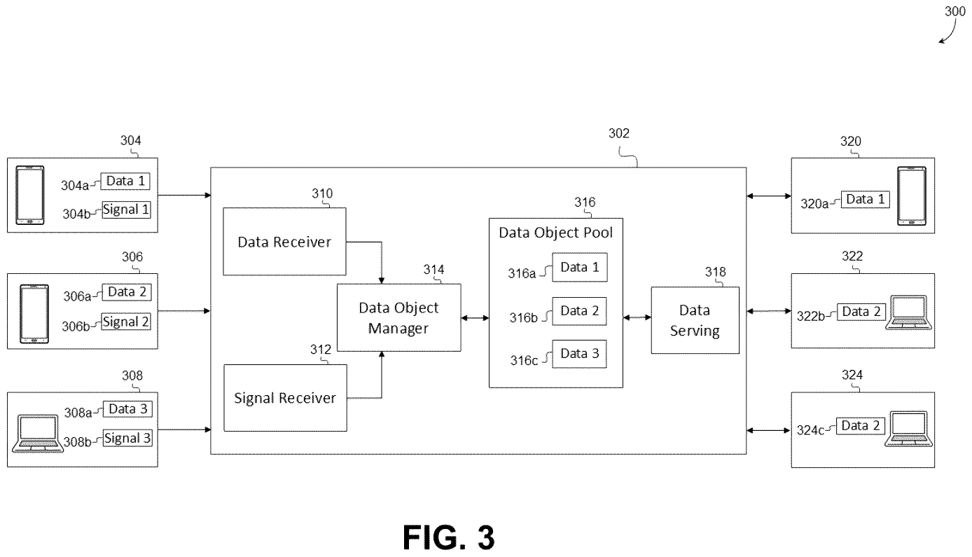

FIG. 3 illustrates a system 300 in accordance with one or more embodiments. As illustrated in FIG. 3, system 300 includes multiple source systems (e.g., 304, 306 and 308), an application server 302 and multiple client systems (e.g., 320, 322 and 324). In one or more embodiments, the system 300 may include more or fewer components than the components illustrated in FIG. 3. The components illustrated in FIG. 3 may be local to or remote from each other. The components illustrated in FIG. 3 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below.

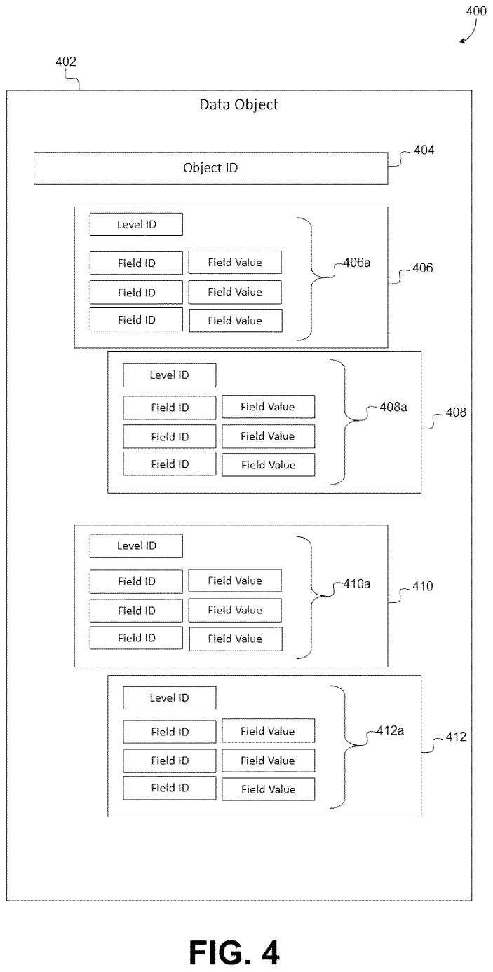

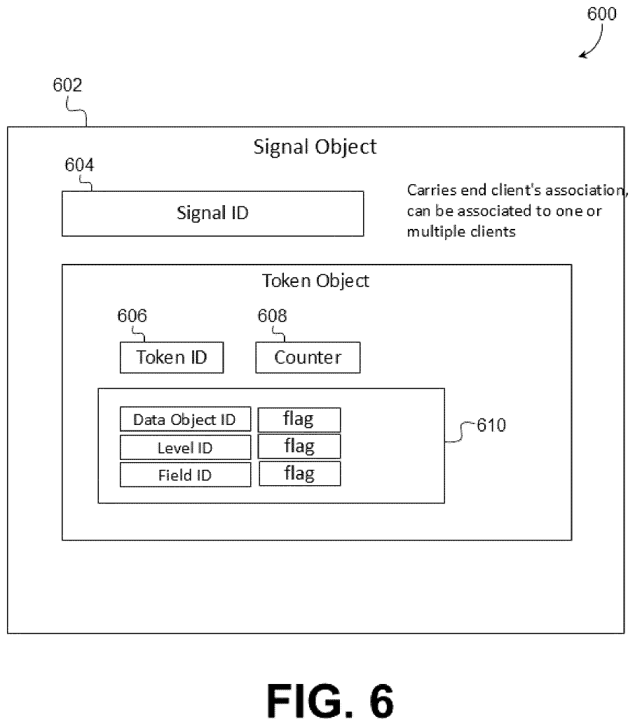

In an embodiment, a source entity (e.g., 304, 306 and 308) refers to hardware and/or software configured to perform operations described herein for transmitting a request to a service 302 which in turn is finally served to entity (e.g., 320, 322 and 324). Specifically, the source system (e.g., 304, 306 and 308) transmits (a) a data object (as depicted in FIG. 4) and (b) a signal object (as depicted in FIG. 6). The signal object may also identify the client system to which the data is intended to. The transmission from the source system can occur continuously over a defined period, providing a steady stream of data or signals to the application server. This transmission persists until the source system determines that it no longer needs to share the data or signals, either due to a change in operational conditions, completion of a specific task, or a deliberate decision based on dynamic system requirements or contextual triggers.

In an embodiment, an application server (302) refers to hardware and/or software configured to perform operations described herein for receiving, Data Receiver (310) and Signal Receiving (312), processing via Data Object Manager (314) and serving via Data Serving (318).

Specifically, an interface, data receiver (310) and signal receiver (312) may receive the request. The service interfaces 310 and 312 exposes an API for receiving service requests. The service interfaces 310 and 312 may expose the API to one or more requesting entities (e.g. requesting entity 304). For example, the service interface 310 may expose an API for receiving requests structured as JavaScript Object Notation (JSON), Simple Object Access Protocol (SOAP), binary instructions, a procedural language extension to Structured Query Language (PL/SQL), Java function calls, mainframe commands, and/or any other type of API request.

In an embodiment, the service interfaces 310 and 312 also exposes an interface for receiving requests issued by one or more other components of the source systems (304, 306 and 308). Specifically, the service interfaces 310 and 312 may expose an API for receiving output corresponding to native function calls that are executed from the source system (e.g. 304).

The data object pool (316) mentioned in FIG. 3 acts as a memo state of data objects in the application server. This allows the system to dynamically manage and process data objects, ensuring that the appropriate data is accessible under the right conditions and enhancing the overall security and functionality of the distributed system.

The Data Object Manager (314) serves as the central control unit of the application server, functioning as the “brain” of the system. It has access to both the data objects and signal objects received from the source systems. The Data Object Manager listens to the incoming signals and, based on these signals, dynamically maintains and updates the state of the data objects in the data object pool (316). This involves several critical functions:
Listening to Signals: The Data Object Manager continuously monitors the incoming signal objects from the data sources. These signals include contextual information, temporal parameters, and specific access control requirements.
Processing Signals: Upon receiving a signal, the Data Object Manager interprets the instructions and requirements conveyed by the signal. This may involve determining the current context, time-based conditions, and the specific access permissions needed for the data object.
Updating Data Objects: Based on the processed signals, the Data Object Manager updates the state of the corresponding data objects in the data object pool. This includes adjusting their visibility (whether they are displayed to client systems), availability (whether they can be accessed in their current state), and accessibility (the level of interaction permitted for each client system, such as read, write, or execute).
Ensuring Compliance: The Data Object Manager ensures that the data access complies with the security policies and operational requirements of the distributed system. By dynamically managing the state of data objects, the Data Object Manager enhances the overall flexibility, security, and functionality of the system, ensuring that only the appropriate users, under the correct conditions, can access the required data.

The Data Servicing embodiment (318) is responsible for delivering the processed data objects to the client systems (320, 322, 324). It acts as the final step in ensuring that the right data is accessible to the right users at the right time. The Data Servicing component interacts with the Data Object Manager to understand the current state of each data object and delivers them to the client systems based on the established access control parameters. This ensures that the data is securely and efficiently transferred, maintaining the integrity and context-specific nature of the data access.

### 3. KEY FEATURES

Below are some of the key features of the invention; other aspects and functionalities are also part of the system, further contributing to its flexibility, security, and adaptability in managing data access across diverse environments.

Dynamic Source Systems: The system allows for the use of source systems that can dynamically influence the state of data objects in connected systems. This dynamic sourcing enables seamless interaction between systems in constrained environments, ensuring that data is available only under suitable conditions and significantly improving security and flexibility in multi-system environments.

Dynamic Data State Modification: This invention provides a dynamic approach to data access, enabling real-time adjustments to the state of data objects based on live inputs from source systems. Unlike static systems, which rely on predefined configurations, this approach adapts to factors like user context, time-based conditions, and evolving access control requirements, ensuring that data is accessible only when appropriate and secure.

Real-time Context-Aware Access Control: By integrating multi-dimensional signals that incorporate temporal parameters and data access control objects, the system provides fine-grained, context-aware access control. Temporal parameters, such as specific time windows or recurring intervals, define when data is accessible, while data access control objects take into account user roles, permissions, and device configurations, offering a flexible and precise framework for access management.

Visibility, Availability, and Accessibility: The invention introduces dynamic control over three critical aspects of data access:
Visibility: Data objects are selectively displayed to client systems based on real-time access conditions.
Availability: Data is only made accessible if the system determines that the current conditions support its retrieval.
Accessibility: The level of interaction with data (read, write, or execute) is defined based on context-specific parameters, ensuring that users can only perform actions that are permitted within the given constraints.

Adaptability to Distributed and Constrained Environments: The invention is designed to operate in distributed systems and environments with complex interdependencies, where access to data must be tightly controlled. It eliminates the need for rigid static configurations, enabling systems to adapt to real-time operational changes, including fluctuating user contexts, data changes, and temporal constraints.

Enhanced Security and Flexibility: By enabling dynamic data access control, the system enhances both security and operational efficiency. It ensures that sensitive data is only available under the right conditions, minimizing the risk of unauthorized access while maintaining system usability. This dynamic, real-time adjustment helps address the challenges posed by traditional static systems, providing a secure, flexible solution for modern data environments.

Wide Applicability: The system is applicable across a wide range of industries, including cloud computing, enterprise systems, healthcare, and financial services, where secure and adaptable data management is critical. By addressing the limitations of static access control models, the invention offers a robust and flexible solution that improves the functionality and security of distributed systems in these sectors.

### DATA OBJECT EXPLAINED

FIG. 4 provides a detailed view of the hierarchical structure of a data object, showcasing how complex data is organized and managed. The Data Object (402) is the main container that encapsulates all the nested levels and fields within it. This hierarchical structure allows for efficient data management and retrieval, enabling the system to organize complex data in a nested manner. The Object ID (404) is a unique identifier for the data object, placed at the top of the structure, indicating that it is a primary attribute of the data object. This unique identifier ensures that each data object is distinctly recognized within the system, facilitating easy access and reference.

Level 1 (406) is the first nested level within the data object and contains a unique identifier, Level ID (406a), for this specific level. It also includes Field ID and Field Value pairs, such as Field ID 1 and Field Value 1 (406b), Field ID 2 and Field Value 2 (406c), and Field ID 3 and Field Value 3 (406d), representing specific attributes and their corresponding values at this level of the hierarchy.

Level 2 (408) is the second nested level within the data object and contains a unique identifier, Level ID (408a), for this specific level. It includes Field ID and Field Value pairs, such as Field ID 4 and Field Value 4 (408b), Field ID 5 and Field Value 5 (408c), and Field ID 6 and Field Value 6 (408d), providing more granularity to the data object.

Level 3 (410) is the third nested level within the data object and contains a unique identifier, Level ID (410a), for this specific level. It includes Field ID and Field Value pairs, such as Field ID 7 and Field Value 7 (410b), Field ID 8 and Field Value 8 (410c), and Field ID 9 and Field Value 9 (410d), further breaking down the data object into more detailed attributes and values.

Level 4 (412) is the fourth nested level within the data object and contains a unique identifier, Level ID (412a), for this specific level. It includes Field ID and Field Value pairs, such as Field ID 10 and Field Value 10 (412b), Field ID 11 and Field Value 11 (412c), and Field ID 12 and Field Value 12 (412d), refining the data object with additional specific attributes and values.

This hierarchical structure of the data object (402) is significant because it enables efficient data management, allowing for easy access and manipulation of specific pieces of information within the overall structure. Each level and field within the data object can be uniquely identified, making it easier to organize, retrieve, and update data as needed. This structured approach is particularly beneficial in distributed systems where context-specific data access and management are crucial for ensuring security and functionality.

### SIGNAL OBJECT EXPLAINED

FIG. 6 provides a detailed view of the structure of a Signal Object (602). This diagram illustrates how the signal object is constructed and how it interacts with other components within the system.

The Signal Object (602) is the primary container that encapsulates all the nested elements within it. This hierarchical structure allows the system to manage and interpret signals effectively, providing contextual information and instructions for data management. At the core of the Signal Object is the Signal ID (604). This unique identifier distinguishes each signal emitted from the source system. It ensures that each signal can be accurately referenced and processed within the system. The Signal ID carries the end client's association, meaning it can be associated with one or multiple clients depending on the use case.

Contained within the Signal Object is the Token Object (606), which includes several key components. The Token ID (606) is a unique identifier for the token, ensuring that each token can be distinctly recognized within the system. It plays a crucial role in associating the signal with the intended client systems. The Counter (608) is a field that acts as a timer or counter, specifying a duration or count after which the associated data should expire and become inaccessible. For instance, the counter might indicate that the data should only be accessible for 100 seconds before it is purged from the system.

The nested structure within the Token Object provides a detailed mapping between the signal and the data object, its levels, and fields. This includes the Data Object ID with an associated flag, indicating the specific data object that the signal is related to, along with a flag that determines the state or action related to that object. It also includes the Level ID with an associated flag, specifying the particular level within the data object that is affected by the signal, along with a flag indicating the action to be taken. Lastly, it identifies the specific fields within the data object that are impacted by the signal, with a corresponding flag to denote the state or action required.

The detailed structure of the Signal Object (602) is significant because it allows the system to efficiently manage and interpret signals, providing the necessary context and instructions for data access and management. By understanding the specific components and their interactions within the Signal Object, the system can dynamically adjust data states, ensuring secure and context-specific data access. The unique identifiers (Signal ID and Token ID) and the nested mapping within the Token Object enable precise and controlled data management, making it easier to implement policies, manage access permissions, and ensure that data is handled according to the specified conditions.

Overall, the Signal Object's structure facilitates effective communication and coordination between the source system, the application server, and the client systems, enhancing the overall functionality and security of the distributed data management system.

### 4. DETAILED PROCESS FLOW

FIG. 3 outlines a comprehensive framework for dynamic data management and secure accessibility in distributed environments. It leverages the seamless integration of data objects and signal objects to establish precise, context-aware control over data states, ensuring that only authorized users or systems access specific information under predefined conditions. From the generation and transmission of signals to the analysis, adjustment, and delivery of data, the process ensures real-time adaptability and scalability. By incorporating flexible access control mechanisms, such as granting, revoking, or partially enabling data access, this flow addresses complex scenarios of data governance while maintaining efficiency and user-centricity. The following steps detail the end-to-end lifecycle of data management, highlighting how source systems, application servers, and client systems collaborate to meet dynamic access requirements.

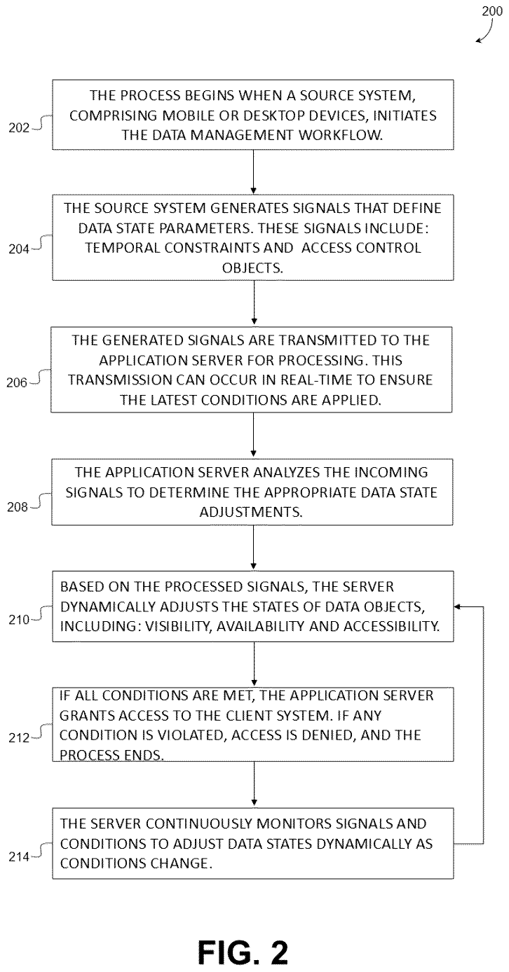

Step 1: Data and Signal Generation (FIG. 2, process 202)

In FIG. 2, the process (FIG. 2, process 202) begins with data and signal generation, initiated by various source systems such as mobile devices and desktops. These source systems (FIG. 3, process 304, 306, 308) are responsible for producing both Data Objects and Signal Objects. For example, Mobile Device 1 (FIG. 3, process 304) generates Data 1 (FIG. 3, process 304a) and Signal 1 (FIG. 3, process 304b), Mobile Device 2 (FIG. 3, process 306) produces Data 2 (FIG. 3, process 306a) and Signal 2 (FIG. 3, process 306b), and Laptop (FIG. 3, process 308) creates Data 3 (FIG. 3, process 308a) and Signal 3 (FIG. 3, process 308b). These signals define the parameters and conditions for data access and state adjustments.

Signal objects encapsulate temporal constraints and access control information, specifying data accessibility conditions, such as time windows or user roles. For instance, a signal might dictate that a particular data object is accessible only during business hours or exclusively to users with administrative privileges.

Step 2: Transmitting Signals (FIG. 2, process 204)

Once the signal and data objects are generated, they are transmitted to the application server (FIG. 3, process 302) for processing which is described in process (FIG. 2, process 204). This step is crucial to ensure real-time data state adjustments based on the latest conditions. The Data Receiver (FIG. 3, process 310) collects data objects, while the Signal Receiver (FIG. 3, process 312) gathers signal objects. Together, they facilitate the seamless transmission of information from the source systems to the application server.

Step 3: Analyzing Signals (FIG. 2, process 206)

Upon reaching the application server, the signals undergo a thorough analysis to determine the required adjustments to the data objects. The Data Object Manager (FIG. 3, process 314) plays a pivotal role in this step, acting as the central unit that integrates and interprets the data and signal objects. By referring to the Signal Object Structure (depicted in FIG. 6) on the Data Object (depicted in FIG. 4), the Data Object Manager evaluates critical fields such as user context, time-based conditions, and access permissions.

For instance, if a signal specifies that a data object should only be visible to managers outside regular business hours, the application server ensures compliance with these constraints. The analysis ensures precise, role-based, and context-sensitive management of data accessibility.

Step 4: Adjusting Data States (FIG. 2, process 208)

Following the analysis, the Data Object Manager (FIG. 3, process 314) dynamically adjusts the states of data objects based on the instructions derived from the signals. These adjustments encompass various attributes, including visibility, availability, and accessibility. The Data Object Structure (as shown in FIG. 4) provides the blueprint for these changes, outlining fields like visibility (whether the data object is displayed), availability (if it can be accessed), and accessibility (defining interaction levels like read, write, or update).

For example, a data object may be set to visible only for a specific role, such as HR personnel, during weekdays. The flexibility and precision of this process enable tailored data state adjustments in a dynamic environment.

Step 5: Granting or Denying Access

With the data states adjusted, the application server decides whether to grant or deny access to client systems. This decision hinges on whether all conditions specified in the signal object are met. If the conditions align, access is granted, meaning the data state is updated in the Data Pool; otherwise, it is denied, purged from the Data Pool.

The system, application server, continuously monitors signal conditions to adapt dynamically to changes in access requirements. For instance, if a user's role changes or temporal constraints expire, the system re-evaluates access permissions in real time, maintaining strict control over data accessibility.

Step 6: Data Serving

Finally, the processed data objects are delivered to client systems through the Data Serving Component (FIG. 3, process 318). This component ensures that data objects are shared only under the specified access control parameters. It closely interacts with the Data Object Manager to maintain alignment with the dynamically adjusted states.

For instance, if a data object is partially accessible to a client system, the Data Serving Component ensures that only the permitted fields are transmitted. This process guarantees secure and context-specific data delivery to the client systems (FIG. 3, process 320, 322, 324).

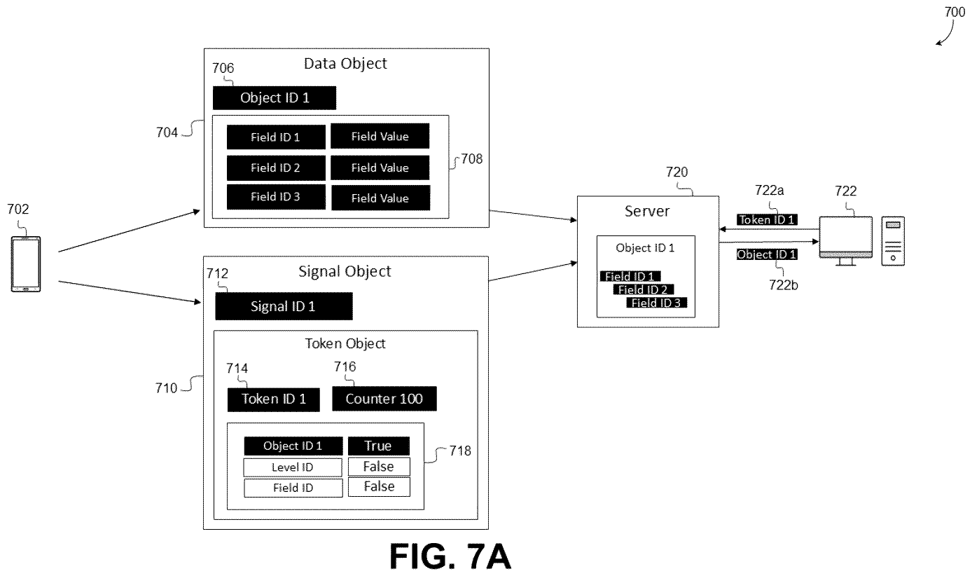

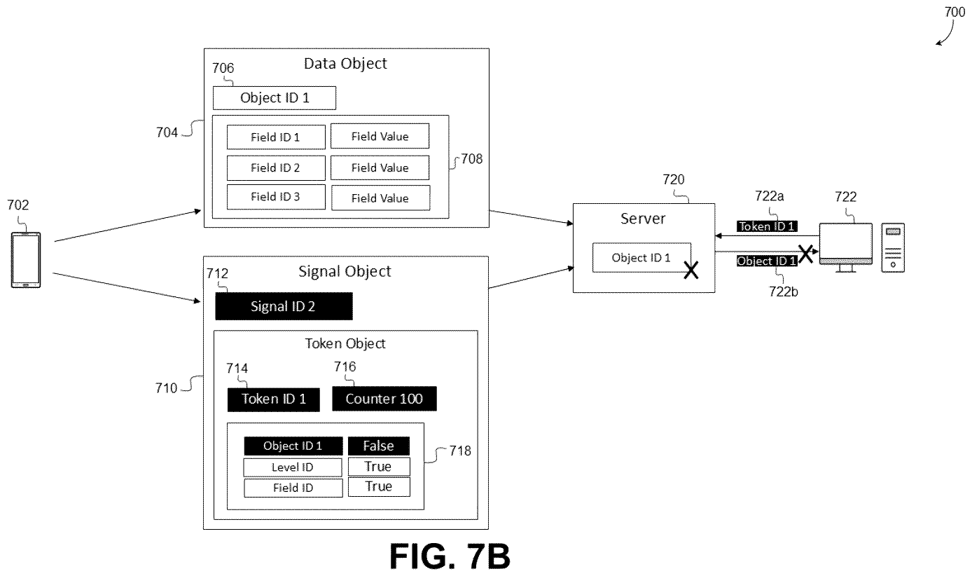

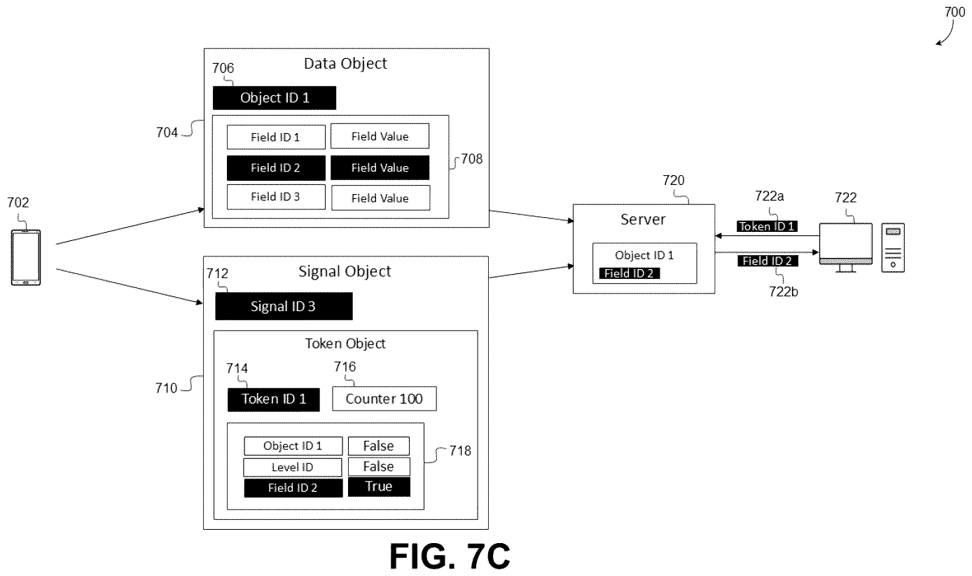

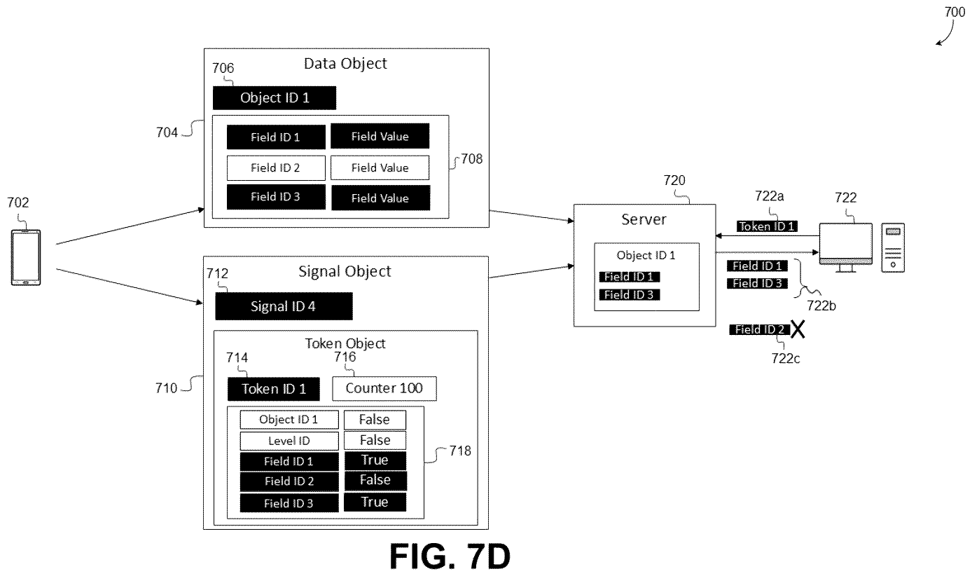

Step 7: Dynamic Data Access Control (FIGS. 7a-7d)

For example, in FIG. 7A, the Data Object (704) includes all fields—Field ID 1, Field ID 2, and Field ID 3 (708)—along with their respective values. Additionally, the Signal Object (712) is sent by the source system. The Data Object (704) contains a unique identifier, Object ID 1 (706), which ensures each object is distinctly identifiable. Based on the unique Object ID 1 sent by the source system, all corresponding field-value pairs are generated.

Similarly, the Signal Object (710) has a unique identifier, Signal ID 1 (712), for any signal emitted from the source system. The Token ID 1 field (714) within the signal object references the target client system(s) (722) intended to receive the signal. The Counter field (716) serves as a timer, indicating that the associated data should expire and become inaccessible to the client system (722) after 100 seconds. The Counter field (716) can also serve different purposes in other scenarios.

Fields such as Object ID 1, Level ID 1, and Field ID fields (718) create a direct, one-to-one association between a data object, its levels/fields, and a given signal, ensuring precise and context-specific data management.

As shown in FIG. 7A, the source system (702) sends the described data object (704) and signal object (710) to the application server (720). The Data Object (704) contains all fields, including Field ID 1, Field ID 2, and Field ID 3 (708), along with their corresponding values. This data object also includes a unique identifier, Object ID 1 (706), ensuring each object is distinctly recognized. Accompanying the data object is the Signal Object (710), which provides instructions on handling the data. This signal object includes a unique identifier, Signal ID 1 (712), for any signal emitted from the source system, and the Token ID 1 field (714) references the target client system(s) (722) intended to receive the signal. Additionally, the Counter field (716) acts as a timer, indicating that the associated data should expire and become inaccessible to the client system (722) after a specified period (e.g., 100 seconds).

The Data Object Manager (FIG. 3, process 314) processes both the data object and the signal, making the complete data object available in the Data Object Pool (FIG. 3, process 316). Subsequently, the client system (722) makes a request using Token ID 1 (722a) to access data from the Data Serving process (FIG. 3, process 318). The Data Serving component then looks at the data pool, retrieves the complete data object (722b), and sends it back to the client.

In FIG. 7B, when Signal ID 2 (710) is received from the source system, the Data Object Manager immediately processes this signal. It determines that Object ID 1 should be made inaccessible to the client since the value for Object ID 1 (718) is set to false. As a result, the Data Object (704) is purged from the Data Object Pool (FIG. 3, process 316), making it inaccessible to the client (722). During this process, all remaining associations of this object, including any server-side or client-side cache, are also invalidated to ensure no stale or unauthorized data remains accessible to the client system.

FIG. 7C illustrates a scenario where the source system (702) sends a selected field, specifically Field ID 2 (708), as part of a Data Object (704) along with the corresponding Signal Object (710). Upon receiving the signal, the Data Object Manager (FIG. 3, process 314) processes both the data object and the signal. It then makes only Field ID 2 available in the Data Pool (FIG. 3, process 316), ensuring that this specific field is accessible based on the signal instructions.

Subsequently, the client system (722) issues a request using Token ID 1 (722a) to retrieve data via the Data Serving process (FIG. 3, process 318). The Data Serving component queries the data pool, retrieves the specific data object containing only Field ID 2 (722b), and delivers it back to the client system, adhering to the defined access parameters.

FIG. 7D illustrates a scenario where the source system (702) sends a selected field, specifically Field ID 1 and Field ID 3 (708), as part of a Data Object (704) along with the corresponding Signal Object (710). Upon receiving the signal, the Data Object Manager (314) processes both the data object and the signal. It then makes the Field ID 1 and Field ID 3, and purges the prior object Filed ID 2 available in the Data Pool (FIG. 3, process 316), ensuring that this specific fields are accessible based on the signal instructions.

Subsequently, the client system (722) issues a request using Token ID 1 (722a) to retrieve data via the Data Serving process (FIG. 3, process 318). The Data Serving component queries the data pool, retrieves the specific data object containing only Field ID 1 and Field ID 3 (722b), and delivers it back to the client system, adhering to the defined access parameters.

What is claimed is:

1. A method for dynamic data state management in a distributed system, comprising:
generating data objects and signal objects by one or more dynamic source systems, wherein the dynamic nature of the source systems enables real-time construction of access control through the generated signals, the signal objects containing conditions for data state adjustments, including access permissions, temporal constraints, and user contexts;
transmitting the generated data objects and signal objects to an application server;
analyzing the signal objects at the application server to determine adjustments to the states of the corresponding data objects;
dynamically modifying the visibility, availability, or accessibility of the data objects based on the analyzed signal objects; and
delivering the adjusted data objects to client systems based on the modified states.

2. A method for real-time access control using temporal data in a distributed system, comprising:
generating signal objects by one or more source systems, the signal objects containing temporal data specifying conditions for data access, including time windows, expiration periods, or periodic accessibility;
transmitting the signal objects to an application server;
analyzing the temporal data in the signal objects at the application server to determine real-time access permissions for the corresponding data objects;
dynamically adjusting the states of the data objects, including visibility, availability, or accessibility, based on the analyzed temporal data; and
granting or denying access to the data objects by client systems according to the real-time adjusted states.

3. A system for managing data access in real-time, comprising:
a plurality of dynamic source systems configured to generate data objects and signal objects, wherein the signal objects define access permissions, temporal constraints, and user contexts;
an application server including:
a signal receiver to receive the signal objects,
a data object manager to process the signal objects and modify data object states based on conditions defined in the signal objects;
a data serving component to deliver data objects to client systems in accordance with the modified states, wherein the states include visibility, availability, and accessibility.

4. A method for conditional access control of data objects, comprising:
receiving signal objects that define conditions for access to specific data objects;
analyzing the signal objects to determine if the conditions are met;
granting access to the corresponding data objects when the conditions are met, or denying access otherwise; and
dynamically adjusting access permissions for the data objects based on changes in the signal object conditions.

5. A signal object for managing data access in a distributed system, comprising:
a signal identifier uniquely identifying the signal object;
a token object associated with the signal identifier, the token object comprising:
a token identifier uniquely identifying the token object;
a counter indicating a duration or count after which associated data becomes inaccessible;
a nested structure mapping the signal to a data object, including:
a data object identifier associated with a flag indicating a state or action related to the data object;
a level identifier associated with a flag indicating an action to be taken at a specific level within the data object;
a field identifier associated with a flag indicating a state or action required for a specific field within the data object.

6. The method of claim 1, wherein the signal objects define access permissions for specific elements of the data objects.

7. The method of claim 1, further comprising continuously monitoring the signal objects to dynamically adjust the states of the data objects in real time.

8. The system of claim 2, wherein the data object manager is configured to interpret temporal constraints in the signal objects to modify data states for time-based access control.

9. The method of claim 3, wherein the conditions in the signal objects include user roles, time windows, and geolocation data.

10. The system of claim 2, wherein the data serving component delivers only updated elements of the data objects to the client systems when a modification occurs.

11. The method of claim 1, wherein the data objects and signal objects are generated by mobile devices, laptops, or desktop computers as the source systems.

12. The method of claim 1, further comprising revoking access to data objects by modifying the signal object conditions dynamically.

13. The signal object of claim 5, wherein the signal identifier is associated with one or more end clients.

14. The signal object of claim 5, wherein the counter specifies that the associated data is accessible for a predetermined duration.

15. The signal object of claim 5, wherein the nested structure includes multiple levels of the data object, each level having a unique level identifier and associated flag.

16. The signal object of claim 5, wherein the nested structure includes multiple fields of the data object, each field having a unique field identifier and associated flag.
